(19) United States
(12) Patent Application Publication
(10) Pub. No.: US 2007/0011669 A1
(43) Pub. Date: Jan. 11, 2007

(54) Software migration

(75) Inventors: Pradeep Varma, New Delhi (IN); Ashok Anand, New Delhi (IN); Donald P. Pazel, Montrose, NY (US); Beth Tibbitts, Lexington, KY (US)

Correspondence Address: Frederick W. Gibb, III;McGinn & Gibb, PLLC, Suite 304, 2568-A Riva Road, Annapolis, MD, 21401, US

(73) Assignee: International Business Machines Corporation, Armonk, NY (US)

(21) Appl. No.: 11/175,741

(22) Filed: Jul. 6, 2005

(51) Int. Cl. G06F 9/44

(52) U.S. Cl. 717/168

(57) ABSTRACT

A procedure for migrating large code-bases is described. An initial migration plan is generated for a given porting project between a source platform and a target platform, which have respective dialect settings. The migration plan specifies a set of migration stages between the source dialect settings and the target dialect settings via intermediate dialects settings. The relative order between migration stages is specified where necessary to account for dependencies between the intermediate dialects. Migration stages of the migration plan are executed in a sequence consistent with the partial ordering specified by the migration plan. Each migration stage is executed as a transition between preceding dialect settings and succeeding dialect settings, from the source platform to the target platform. Migration issues between the two dialect settings are identified, and the software code is modified accordingly to operate under the succeeding dialect settings rather than the preceding dialect settings. The modified software code is built according to the succeeding dialect settings. Migration stages are executed in turn, from the dialect settings of the source platform to the dialect settings of the target platform, at which stage migration is complete.

### FIELD OF THE INVENTION

The present invention relates to software migration of applications from one source dialect to a target dialect.

### BACKGROUND

Formal approaches pertinent to porting include the DMS approach, which argues for a separate specification of real-world code transformation for a multitude of languages. Both a formal specification of the language is required as well as the desired source-to-source transformation. DMS is described in: Baxter, I. D., Pidgeon, C. and Mehlich, M. “DMS: Program Transformations for Practical Scalable Software Evolution”, In Proceedings of the IEEE International Conference on Software Engineering (ICSE'04), Edinburgh, United Kingdom, May 23-28, 2004, pages 625-634. No software engineering processes is described for DMS, only that automatic transformation be used.

Source-to-source transformations are also taught in: Devanbu, P. T. “GENOA—A Customizable, Front-End-Retargetable Source Code Analysis Framework”, In ACM Transactions on Software Engineering and Methodology, Volume 8, No. 2, April 1999. This work teaches how to use a real-world compiler's front-end to handle the multitude build/compile settings involved in performing source-to-source transformations. The content of this reference is incorporated herein in its entirety.

U.S. Pat. No. 6,501,486 issued Dec. 31, 2002 to International Business Machines Corporation describes a means for generating object implementations in distinct languages from a common object definition language whereby an object defined in the common language is mapped to its implementation, for example, in C++ by walking its common form and generating the implementation counterpart.

GNU Autotools (autoconf, automake, libtool) (available from http://www.gnu.org) provide functionality that assists adaptation of software package sources to different platforms. The autoconf tool generates shell scripts to match package needs with discovered platform capabilities. The automake tool encourages manual build abstraction into a higher-level specification (“makefile.am”) from which platform-specific “makefiles” can be automatically generated. The libtool simplifies building shared objects (dynamically linked libraries). These tools can be helpful in certain contexts, but are used individually, on a case-by-case basis.

The techniques described above are useful in particular contexts and applications. Limitations arise, however, when dealing with large-scale, real-world, source-to-source migration projects, and an improved approach to dealing with such projects is required.

### SUMMARY

A tool-based, semi-automatic, source-to-source code transformation process is described herein for migration (porting) a code base. This transformation is described in the context of large-scale source-to-source migration of C/C++ code-bases. This context is dictated by commercial significance, as well as the complexity of the problem. A primary factor contributing to this complexity is the close relationship of these exemplary languages to typical machine architectures, the memory model used (which leads to difficult pointer issues/analysis, Endian issues) and the concomitant philosophy, which can be summarized as: “Make it fast, even if it is not guaranteed to be portable”.

C's language definition (similarly the “superset” C++) allows vendor divergence on different types of behaviors, such as: “implementation-defined behavior”, “undefined behavior”, “unspecified behavior”, and “locale-specified behavior”. The C programming language standard is published as ISO/IEC 9899:1999 C standard (1999) and ISO/IEC 9899:1999 C Technical Corrigendum (2001). The C++ definition is published as ISO/IEC 14882:1998 C++ standard (1998). These publications are available at: http://www.iso.org. Consequently, the languages tend to have very complex and brittle build settings relating to the compilers used, the command line options, and so on.

Extreme Programming (often referred in abbreviated form as XP) is an informal set of practices and approaches related to software programming. Examples of such practices are those referred to as: planning game, testing, refactoring, “daily build”, small releases, simple design, and pair programming. XP is recommended for small teams, and is generally accepted to have scalability limitations. XP is used as the software engineering process framework for the tool described herein, though some of the scalability difficulties pertaining to basic XP are addressed.

The procedure for migrating large code-bases first involves an initial migration plan, which is generated for a given porting project between a source platform and a target platform, which have respective dialect settings. The migration plan specifies a set of migration stages, also referred to herein as migration steps, between the source dialect settings and the target dialect settings via intermediate dialects settings. The relative order between migration stages is specified where necessary to account for dependencies between the intermediate dialects.

Migration stages of the migration plan are executed in a sequence consistent with the partial ordering specified by the migration plan. Each migration stage is executed as a transition between preceding dialect settings and succeeding dialect settings, from the source platform to the target platform. Migration issues between the two dialect settings are identified, and the software code is modified accordingly to operate under the succeeding dialect settings rather than the preceding dialect settings. The modified software code is built according to the succeeding dialect settings. Migration stages are executed in turn, from the dialect settings of the source platform to the dialect settings of the target platform, at which stage migration is complete.

Individual iterations or small groups of iterations correspond to a work unit between individual daily builds. Small releases can be identified at daily build points, as needed. A planning tool suggests the migration stages for a given project, and the relative order among them based upon any dependencies that may exist. Testing support for a daily build involves stub libraries that have a cache component, which can be used to inventory run-time library usage (library calls) on a customer's source platform. The stub libraries enable more comprehensive daily builds all the way up to the final integrated acceptance test, after migration is complete. The planning component and testing support component conducts code refactoring for porting fixes at individual migration stages. A standard inventory of code sources (which undergo source-to-source transformations), and an optional baseline test against which a final optional acceptance test is performed is presupposed.

### DESCRIPTION OF DRAWINGS

FIG. 1 is a schematic representation in overview of the process described herein.

FIG. 2 is a schematic representation of the minimal dependencies between practices and resources.

FIG. 3 is a schematic representation of a full graph and a corresponding abstraction for a 4-Boolean variables domain.

FIG. 4 describes the architecture of a run-time stub library.

FIG. 5 is a flow chart in overview of an algorithm for performing the process described herein.

FIG. 6 is a schematic representation of a computer system suitable for performing the techniques described herein.

FIG. 7 is a schematic representation of an abstract graph for an example migration.

FIG. 8 is a schematic representation of marked AND/OR trees constructed for the example described with reference to FIG. 7.

FIG. 9 is a schematic representation of a partially ordered result of the overall plan for the example described with reference to FIGS. 7 and 8.

### DETAILED DESCRIPTION

Migrating a C/C++ computing software program involves performing a meaning-preserving source-to-source transformation that rewrites a program written in a conforming or non-conforming source-platform dialect into a target-platform dialect. Starting from an initial configuration comprising a C/C++ dialect (including the operating system, hardware and library-related flags), the next dialect to migrate to is selected based on the work size and rebuild considerations. This process is performed repeatedly until the software is migrated completely from the source platform dialect settings to the target platform dialect settings.

The following reference, referred to herein as Pazel et. al., describes a framework for incorporating the process described herein of software migration: Pazel, D. P., Varma, P., Paradkar, A., Tibbitts, B., Anand, A. and Charles, P. “A Framework and Tool for Porting Assessment and Remediation”, IEEE International Conference on Software Maintenance (ICSM '04), Sep. 11-17, 2004, Chicago, Ill. The content of this reference is incorporated herein in its entirety. The above-mentioned reference describes walking over an intermediate form (for example, Abstract Syntax Tree) to perform porting issue analyses and remediation. Pazel et. al., demonstrates a working prototype based upon the work described by Devanbu: Devanbu, P. T. “GENOA—A Customizable, Front-End-Retargetable Source Code Analysis Framework”, In ACM Transactions on Software Engineering and Methodology, Volume 8, No. 2, April 1999. The content of this reference is also incorporated herein in its entirety, and any subsequent reference to either is to be taken as a reference to both.

Pazel et al. describes a basic tool for semi-automatic detection and fixing of porting issues or computation of metrics (like number of program expressions, statements, and so on) at a given target setting. The overall planning and testing components described herein enables a software process capable of both macro and micro planning and detailed semi-automatic execution of individual migration steps.

As described in further detail in the subsection entitled “Orchestrator”, the space of C/C++ programs is organized into a Cartesian space of language dialects (or dialect settings) among which the orchestrator assists planning by projecting work requirements for <from, to> dialect choices. This enables computation of a plan comprising of choices of <from, to> shifts of dialects to migrate from the initial dialect to the final dialect; that is, dialect settings of the source platform to dialect settings of the target platform.

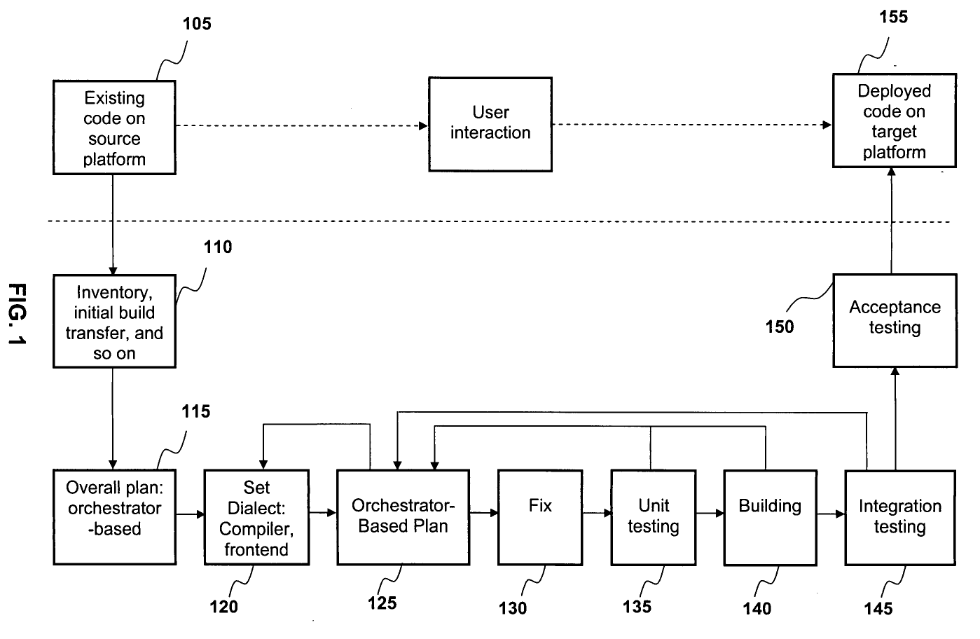

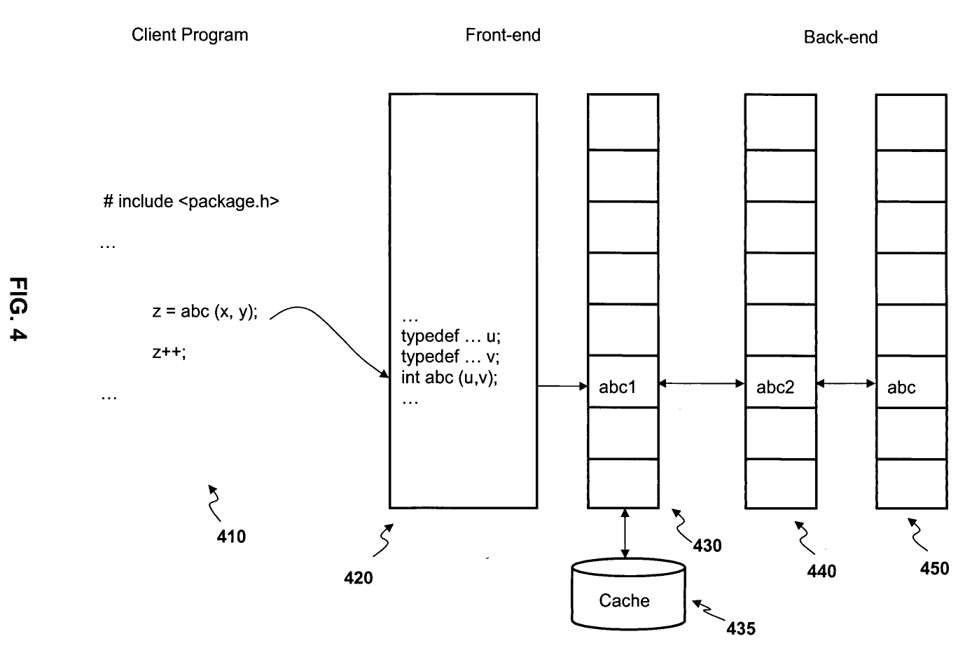

FIG. 1 schematically represents the overall process described herein, in which the same compiler settings can run through several consecutive iterations. One starts with existing software code on a source platform 105. An inventory is taken in step 110, and an initial build knowledge transfer is performed. This involves collecting the entire set of program source files that are to be migrated, along with associated build files (such as makefiles), data files and documentation of manually kept knowledge related to building and running the program sources. This step may be performed manually, or using technology similar to the GNU Autotools set that inventory a package's requirements, among other things. Test data (testcases—input/output) of a built and running program on the target platform may be collected for acceptance testing (in subsequent step 150). The approximate usage of run-time libraries (specific function calls, library data references) is collected in a cache, which is described below in further detail with reference to FIG. 4. The cache can be used in the migration procedure, as and when needed.

Overall planning creates a “roadmap” of the entire migration procedure in step 115, which involves a partially ordered set of migration stages. The roadmap enumerates the dialect migration steps to undertake (namely dialect edges, in <from, to> form), and any required temporal order between these migration steps. For example, an edge representing switching off of a given library package option may be preceded by another edge switching on a substitute library package option.

Subsequent integration planning refines this roadmap by making definite, local choices (that is, entirely ordered), one at a time. In the case of the example noted above, the decision regarding relative placement of other porting steps in-between or vis-à-vis each other may be decided locally, depending on resource constraints such as available machines/human expertise in a given work week, and so on. Besides identifying the (say n) choices, the orchestrator helps to incrementally select one out of the (worst-case n!) orderings and assists each individual step of the port. To accomplish this, the functionality of the orchestrator can be provided as an extension of the refactoring tool described in Pazel et al, for individual iteration plans, as described below in further detail.

A porting project comprises iterations of step 120 through to 140, preceded initially with an overall planning step 115, using the source platform dialect settings. Once iterations begin, appropriate settings are first selected (or re-used) for the compiler and front-end components used in the iteration. Starting from source platform settings, the process shifts through intermediate dialects (and associated settings) until finally the target platform settings are reached. In a given iteration, the analysis proceeds on the target dialect of the previous iteration. Each iteration results in modified code, which is tested on a target dialect of the present iteration, which then later becomes the initial dialect of the next iteration. After dialect settings choices are made in step 120, manually reflecting the local iteration planning decision fine-tuning the overall plan, the orchestrator organizes XP stories (and tasks) in terms of compilation units/files in step 125, each backed up with a detailed work plan for steps 130 to 145. Each work plan 125 comprises of largely automatically-detected potential/exact porting issues per unit, which also serve to indicate the vicinity of localized tests to be performed to verify the correctness of the iteration's porting effort. The work plan also includes the planned tests effort for the iteration. Note that the list of porting issues in a work plan need not be exhaustive and a discovery of additional issues may transpire at the time of tests. Some “slack” in the projected work plan needs to be maintained for such a contingency, as one aim of iterative porting being to spread the unknowns evenly for mitigating overall testing cost.

Each iteration begins with the work plan and tests generation (including re-use from previous iterations) in step 125, and goes on to code remediation/refactoring in step 130, unit testing in step 135, and an optional integrated build in step 140. Integration testing in step 145 is an optional step that may be desirable.

Typically a compilation unit is not broken across stories, unless the unit is very large. Individual team members can pick stories based on manifest porting issues, and generate white-box-based and (optionally) black-box-based test cases. A refined estimate of the effort/time required to resolve these porting issues can be generated based on these test cases.

Test design is preferably performed using white-box and structural techniques to exercise the code around each porting issue. Integration/functionality testing may not be feasible in all iterations due to the lack of customer-provided tests, and the unavailability of library support for a platform setting. Test-based design and development can be expected to result in “better” software quality. A lack of customer tests can be ameliorated by the use of team-generated test cases. Test cases that reflect real-life software use patterns are desirable. Developing such test cases is easier for migration of existing code than for new code development, since usage information for the pre-existing sources can be collected.

Testing and debugging support may leverage open-source tools such as the C/C++ Development Tools (CDT) produced under the auspices of the Eclipse Foundation (further details concerning CDT are available from http://www.eclipse.org) to integrate to standard compilers such as GCC (GNU Compiler Collection available from http://www.gnu.org) to compile the specific dialects needed at the <from, to> platform settings. At the user's discretion, breakpoints may be inserted at valid debugging program points nearest and preferably preceding individual porting issues listed in a story. Breakpoints cause the running program to be stopped, and inspection of the current state can be performed. Eclipse-based debugging sessions run concurrently (for example, by a pair of programmers) at both from and to settings help in identifying and correcting a problematic fix. Breakpoints inserted to the code can be manually adjusted to accommodate finer inspection, especially for manual refactorings. The current state of the running program can be assured to match in both versions of the program. If differences are found, the inspection of the code differences that led to the changes can be performed, comparing the “from” and “to” (that is, before and after) state of the source code. Both breakpoints automatically inserted by the refactoring tool (and breakpoints manually inserted or adjusted by users) can be useful at ascertaining correct program results.

The refactoring tool described in Pazel et. al. is capable of identifying the porting issues and computing various metrics, and fixing these porting issues in a semi-automatic manner. The orchestrator leverages this refactoring tool to compile a story, and to generate effort-estimates based on user-supplied formulae. The pair debugging process described above can similarly benefit from synchronous debugging techniques, whereby program states of distinct programs can be inspected and compared at specific program points. The program points are the porting issue points compiled in a story.

Refactoring is preferably based upon a real-world compiler frontend (such as described in Devanbu et. al), an exemplary frontend being the C/C++ language tool from the Edison Group (refer to http://www.edg.com). The parser produces an AST representation for the program. The analysis and remediation plug-ins are Java classes (or “rules”) that work on the AST, and produce the detected porting issues in an encapsulated form. Eclipse may provide an Integrated Development Environment (IDE) as presented to the end user and a tool platform with extensibility to interoperate with an open community of tool enhancements. For example, the refactoring tool demonstrated by Pazel et. al. operates with the CDT (C/C++ Development Tool for Eclipse) such that the built-in C/C++ editing, inspection, build, and debugging tools can be used to augment existing capabilities provided by the refactoring tool.

The current components may build on Edison Group's AST and error log representation for porting issue analysis and remediation. Error handling is a standard feature of most compiler tools, and a log of the errors encountered and dealt with is kept by the compiler tool. Such errors, as identified by a compiler, may be listed as porting issues, or issues to be addressed in individual work plans. A tool component manages porting issues and their relationships with each other, including issues across multiple files. Types of porting issues detected include, but are not limited to, implicit cast issues, variable scoping issues, and API analysis relating to migration from Sun/Solaris C to Linux/GCC. Each detected porting issue has a suggested remediation. Semi-automated remediation is offered in some cases, with optional user interaction.

A “daily” build is best done as regularly as possible. Thus dedicating a (make) expert with the role of build engineer is preferred. Build upgradation (makefile remediation), may be implemented manually, with assistance from the orchestrator's choice and enumeration of <from-to> settings per compilation unit. Similarly, remediation/refactoring automation assists in successful software change integration by reducing inconsistencies and mismatches. A successful daily build means complete successful integrated testing, inclusive of any code fixes needed to pass the tests. Approximations of the full build are complete unit build, which implies passing unit tests after any required fixes.

As a practical matter, team member mobility among files to a degree is possible, though continuity with a compilation unit reduces work time due to increased familiarity. Since testing is not exhaustive, increased mobility offered by pair programming maintains continuity while increasing quality. Depending upon the extent of automated support available for the kind of porting issues in a particular story, the extent of pairing can be decided. Using programming pairs can be valuable in solving harder problems with significant learning and design considerations, such as Endian problems, whose automatic and general detection is an undecidable problem. Experts with a high level of relevant skill are best left mobile, for assisting difficult cases on need.

Overall and Iteration Planning—Orchestrator Overview

As is recognized, each choice of compiler explicit/implicit flag settings can be considered as a distinct dialect of the C/C++ language. The hundreds of settings thus can be classified as either pertaining to extension features (variables E1 to En), or parameters/qualifiers (Q1 to Qm) in the following. C/C++ can be viewed as a parameterized family of languages, with each parameter choice (for example, size of char, int, short) determining specific members of the family. An extension of the language on the other hand adds (that is, unions) a new set of programs, manifesting the extension feature over a common base.

The space of C/C++ programs is organized into a Cartesian space of language dialects among which the orchestrator assists planning by projecting work requirements for <from, to> dialect choices. Indeed, the set of programs represented by a dialect comprising extensions E1, . . . En and parameters Q1, . . . Qm in a C base language can be denoted as:
D<<Dialect(E1, . . . En, C, Q1, . . . Qm)>>=(U_{E ε Pow {E1, . . . En}}E<<C, E>>)∩P<<Q1>> . . . ∩P<<Qm>>
where D<< . . . >>_is the denotation map supported by E and P functions. P maps a parameter to the set of all possible C dialects with the given parameter fixed. Extensions are enumerated in all combinations by generating their powerset (Pow), followed by mapping a combination and the C base to its programs set. Union over all the extension combination sets followed by intersection with the parameters' denotation yields the dialect's meaning. For C++, the base language indicator C changes to C++ in the above.

Table 1 below presents a code fragment for a C dialect (represented, in the form above, as Dialect(oldSun, C90, C, 32-bit, LE)), which is parameterized by standard 32-bit settings for numerical types and little Endian platform setting (for scalar quantities).

TABLE 1

| | |
|---|---|
| | . . . |
| 1 | struct complex {double real, imaginary;} c = {0, 0}; |
| 2 | extern float X[10]; |
| 3 | union {int data; bytes[4];} a; |
| | . . . |

| | |
|---|---|
| 4 | for (long i = 1; i < 10; i++) |

| | |
|---|---|
| 5 | {c.real = X[i] //* divide */ i |

| | |
|---|---|
| 6 | + c.real;}; |

| | |
|---|---|
| | . . . |
| 7 | c.imaginary = X[i]; |
| | . . . |
| 8 | a.data = c.real; |
| 9 | if (*((int *) &i) != ((int) i)) /* big endian */ |

| | |
|---|---|
| 10 | printf(“a's msb: %d \n”, a.bytes[0]); |

| | |
|---|---|
| 11 | else /* little endian */ |

| | |
|---|---|
| 12 | printf(“a's msb: %d \n”, a.bytes[3]); |

The code fragment of Table 1 above is base C with old Sun compiler extensions and the ISO C90 features. Consider a migration of the program to a modern C99 compatible dialect, with 64-bit settings on a Big Endian platform, namely Dialect(C99, C, 64-bit, BE). The dialect variables and their manifest values for the code fragment of Table 1 above are: C-90-Extensions=ON/OFF, C99-Extensions=ON/OFF, oldSun=true/false, Endian=LE/BE, WordSize=32-bit/64-bit. Representing true values with the variable name and the others directly by the variable values, the dialects as described above are Dialect(C99, C, 64-bit, BE), and Dialect(oldSun, C90, C, 32-bit, LE)).

Porting issues in the code fragment of Table 1 above are listed as follows:

| | |
|---|---|
| line 1 - | shift to C99's support for complex numbers for |
| | improvement; |
| line 3 - | potential Endian problem, depends upon union's use; |
| line 4 - | old Sun style for statement with lexical scope beyond the |
| | loop body; |
| lines | shows a quiet change with no static error manifestations but |
| 5-6 - | different run-time behavior - C99's C++ style |
| | comments specify c.real = X[i] + c.real |
| | while the older dialect |
| | specifies c.real = X[i]/i + c.real. |
| line 7 - | references variable i declared in old Sun for scope of line |
| | 4, outside of the loop body; |
| line 8 - | is an implicit cast - a downcast from floating to integral |
| | with differing compiler warnings. |
| line 9 - | predicate is a faulty Endian platform detection test, which |
| | does not work if long and int have same size, which is the |
| | default in 32-bit platform. |

On the source dialect, the Endian test works incorrectly, but still happens to choose the correct little Endian branch and on the target correctly selects the Big Endian branch. Consequently, the most significant byte of the union data is correctly identified and the code fragment is Endian safe (for this pair of dialects). Migration of the code fragment present in Table 1 above can either be performed in one shot, or can be staged per dialect variable change. Change to 64 bit types can be broken further into separate long size shift, pointer size shift, and (optional) long double size shift.

Migrating codebases is a multi-file problem (file×dialect×dialect)*, of which for convenience, we only describe the single file (with includes) problem in the present section. In general, identification of the minimum effort steps per file by which migration can take place is preferred. Once such data is available at the finest resolution, coarsening the same into “day-long” team efforts can be done either intra file or inter file. With this context, the general single-file (with includes) problem is further explored next.

Overall and Iteration Planning—Orchestrator Details

A given E or Q is actually a K-valued variable (a tuple with K states), with the value of K usually two (Boolean—ON/OFF or true/false). The presence of an E/Q in a dialect is as described above and reflects a non-default active value for the variable (for example, extensions “on” rather than “off”).

As an example, for the code fragment presented in Table 1, the dialect variables and their manifest values are as follows: {C-90-Extensions=ON/OFF, C99-Extensions=ON/OFF, oldSun=true/false, Little-Endian=true/false, Big-Endian=true/false, WordSize=32-bit/64-bit}. Suppose that the default wordsize is 16-bit and the default Boolean values are OFF/false. Thus the dialects described with reference to the example of Table 1 above manifest only non-default values in their descriptions, namely Dialect(C99, C, 64-bit, BE), and Dialect(oldSun, C90, C, 32-bit, LE)).

Consider each dialect in an extended form, enumerating the space of all possible E and Q variables with corresponding values, which are mostly “off”, by default. Consider the space of all feasible dialects as a directed graph whose vertices are individual dialects, and whose edges are migration steps from one dialect to another. Migration from one dialect (vertex) to another involves choosing one of many paths in the graph from a source dialect to the target dialect, based on attributes such as minimum effort, small even-sized effort steps, daily build feasibility at individual steps, and so on. Size attributes are specific to a given migration project—the effort required is commensurate to the complexity of the porting issues contained in the code-to-be-migrated along an edge. Whether build and testing can be performed at a dialect vertex depends upon the availability of the requisite compiler, hardware and run-time libraries support. Daily build feasibility, which involves building and testing, is decided by the presence of such support at individual dialect vertices.

The source-to-source transformation tool described herein (which combines the orchestrator tool described above, and the refactoring tool described with reference to Pazel et al.) is largely front-end driven, and supports a broad set of dialects. For example, an object code generator component is not a part of the transformation tool. Test support, on the other hand, requires full compiler support for a given dialect, the availability of which along with supporting hardware cannot be assumed in general. Run-time libraries, if available, may require remapping library calls to different functions, which adds to the work effort estimate for a given step. Availability of run-time libraries in portable source form (for example, GCC libraries), provides a convenient, zero-remap-effort answer, if available.

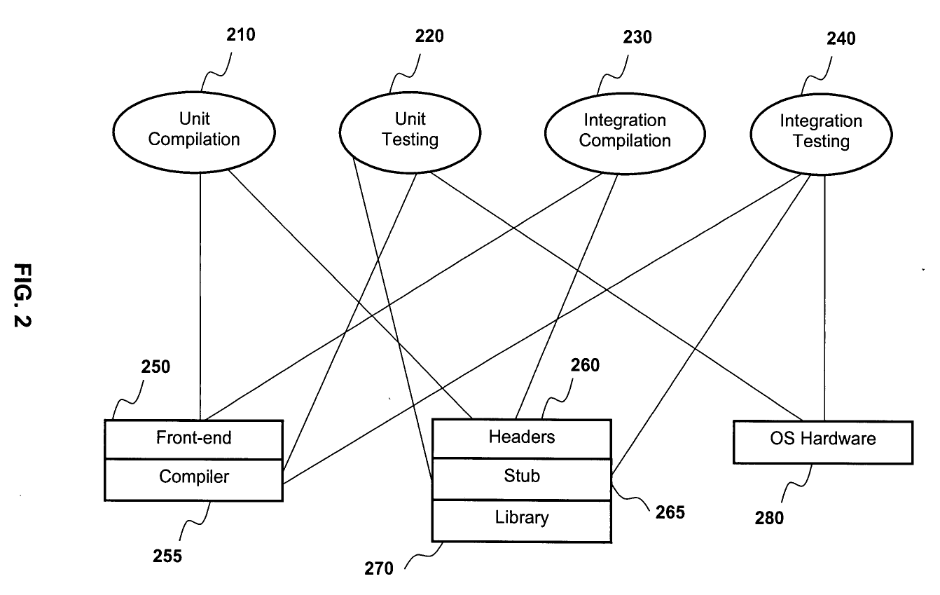

FIG. 2 schematically represents the minimal support requirements for particular individual practices. These practices are depicted as unit building 210, unit testing 220, integration building 230 and integration testing 240. The support requirements are indicated in groups. A front-end 250, and a compiler 255 form one group, and in another group runtime-libraries support is listed, namely headers 260, stubs 265, and the full libraries 270 themselves. Finally, the operating system/hardware 280 is treated as one support unit. The minimal support required by particular practices is indicated by the lines connecting practices and support requirements. For example, unit building 210 requires the minimal support of the front-end 250 and headers 260. Shifting to a lower level (such as, from the front end 250 to a compiler 255) implies a more extensive support, for example, for interpretation of dialect/flag settings dependent on an inter-procedural analyzer component of the compiler.

The combinatorial explosion in enumerating all E and Q tuples for the migration space makes a direct use of the space intractable, since enumeration cannot be performed in polynomial space (or time). The graph can be collapsed into a smaller abstraction that covers all desirable details. For vertices of the graph, the abstraction comprises a (linear) enumeration of the E and Q variable value pairs along with the constraints on combining them to form valid dialects. The constraints supported are done so by implication (for example, E1 [symbol] E2). By choosing one value per variable from the abstraction, individual vertices of the full graph can be resolved, with implications checking validity of the same. One should be mindful that traversing a migration along an edge generally constitutes an atomic action (that is, is not easily further decomposable). The transformation tool in this aspect may contain policies that facilitate the porting process. If this atomic step is attempted to be broken into smaller steps, the program in the intermediate state may not compile or be capable of automatic analysis at either the iteration source or the iteration target dialect settings. Wading out of such a scenario may impose extensive reliance on the standard compiler's error log feature to whatever extent such a generic feature may be of assistance in the porting exercise.

Abstract (directed) edges in the described representation enumerate only intra-variable value changes. Thus, intra-variable state changes are straightforward to represent in terms of the vertex abstraction described above. An edge can optionally carry a synchronization constraint identifying other edges with which the edge is synchronous. The synchronization constraint is a barrier requirement that a change of the variable along the edge be accompanied or preceded by changes in other variables along the synchronized edges. Precedence includes pre-existence of the variables in the changed state and the edge is considered to have been executed by pre-existence (prior to migration). Intra-variable changes are enumerated by explicit edges. There can be multiple edges for the same source and target abstract vertices, as long as each edge carries a different synchronization constraint. Motivation for synchronized edges comes from the need to migrate some language features directly into others without an intermediate step of shifting the program into a featureless base language (for example, from one concurrency/communication extension/library to another without sequentializing in-between). A synchronized edge can represent any edge in the full graph, by capturing all the variables changed by the full-graph edge in one synchronous step.

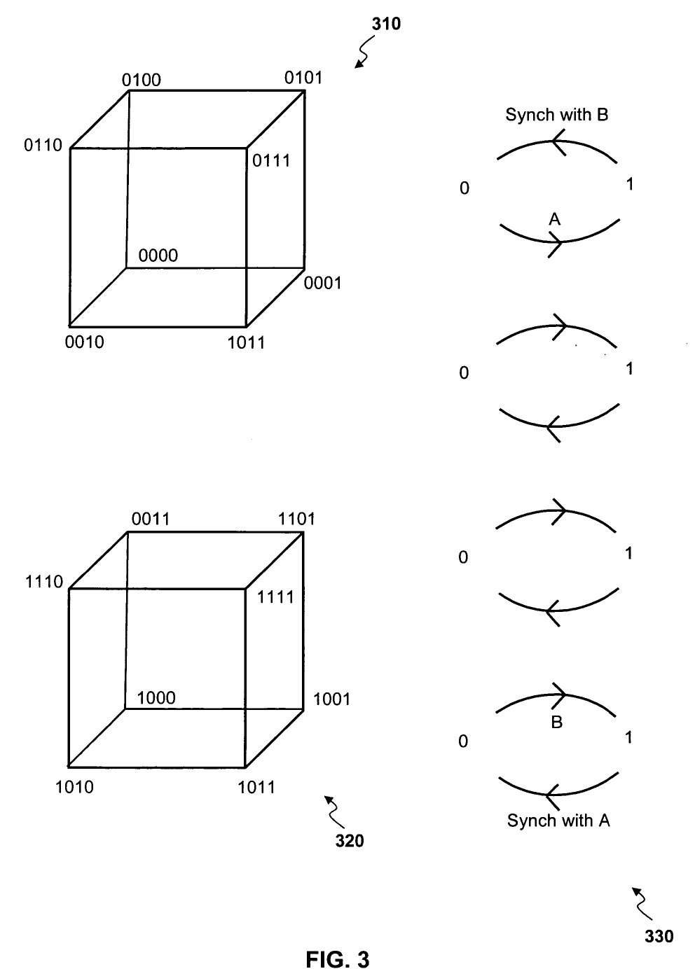

FIG. 3 presents a full abstract graph representation for a 4-Boolean variables domain. Variable values are shown as binary bit patterns in full graph (cubes). In abstraction (right), the most-significant bit (MSB) is laid at top, and the least-significant bit (LSB) at bottom. The full graph shows merged directed edges as bi-directional edges for brevity and shows only an edge subset. The synchronized abstract edges ensure that two concerned variables are not turned off together, in a migration process.

Tool support, defined as vertex attributes in the full graph, shifts to the following computation in the abstraction. For a given tool, a Boolean mapping from individual variable value pairs to yes-support or no is defined. A dialect has the given tool support if the conjunction of the co-domain Booleans that its individual variables map to is true for the tool.

Effort attributes annotate abstract edges, just as full-graph edges are annotated. This assumes that all the concrete, full-graph edges represented by an abstract edge have the same effort attribute as the abstract edge itself This assumption is reasonable as a first-order approximation for the migration domain, wherein the bulk of the transformed code remains unchanged, analysis cost is tied to the bulk code, and direct interference among changes is a minority. Since test/debug support at individual vertices cannot be assumed, effort estimates exclude these activities. At the overall planning stage, the absence of test/debug effort estimate is reasonable if such efforts are evenly spread throughout the migration project. At the iteration planning stage, these costs can be fine-tuned into the local cost by including estimates for the white-box/black-box tests planned for the iteration. All effort weights are positive quantities. A dialect shift along a synchronized edge accrues an effort equal to the sum of the weights of the individual (non pre-existence) edges in the synchronization set. Computing effort attribute is a project-specific exercise, involving tool-based source code analysis. Containing abstract edges to one degree of freedom (that is, one variable—its value changes) contains the number of analyzers required to linear in the number of variables in the system (the from-to value combinations for the variable can be analyzer arguments).

Use of Stub Libraries for Testing

As described above, testing practice requires the availability of run-time libraries that an application can link to and invoke, as needed. The availability of such libraries for porting, such as in an outsourced context, or on the target platform, cannot be assumed. Since the porting process described herein steps through several intermediate platforms to reduce and make the porting work more manageable and testable in any iteration (and overall), there is a need for run-time library support for platforms other than the customer/source platform. How this need is met by providing approximate stub libraries is described as follows. The libraries have a cache component, whereby library usage at the customer/source platform can be captured as a part of the inventory process, for re-use during porting. Such usage capture may be the only feasible way to do testing in scenarios in which no actual library process is available for doing the port. All that is available for testing is the library usage inventory, captured as described below, for example, during baseline testing on customer premises.

A stub library comprises a cached front-end component (including package headers) for integrating with a client program in standard fashion, with calls to the library either being served by locally cached answers in the front-end, or by remote invocations of a back-end on a platform supporting a live image of the library. Variations of the method, including a predetermined set of library calls, a dynamically determined set of library calls, and varying degrees of cached results and cache revamping for the same are also described.

A source-to-source transformation toolkit is minimally compiler front-end driven and need not require a full language compiler. Test support, on the other hand, requires full compiler support for a given dialect, the availability of which along with supporting hardware cannot be assumed in general. The availability of run-time libraries is also a requirement, the presence of which in portable source form (for example, for open-source software), provides the easiest answer, when possible. When regular libraries are not available, substitute stubs, derived as described herein, can be used to provide test support.

These substitute stubs comprise a cache-function front-end and a (distributed) library-process back-end on a different platform. This comprises communicating to the back-end process for library invocations by marshalling/un-marshalling parameters (and also call remapping since function interfaces on different platforms may differ somewhat), so that the remote library process can serve in place of a local library. The cache in essence reduces communication overhead and response time by referring to locally stored data instead of remote calls to the library functions. In case no remote library process is available at all, the cache serves as the sole means to serve library calls from the application program. To take into account such a possibility, step 110 described with reference to FIG. 1 can be modified to include an optional library usage inventory step.

Use of the stubs can invoke any combination of the optional cache and optional back-end components. For the cache only to be invoked, the set of calls has to be predetermined, the collation of which prior to stub invocation can be carried out by appropriate tracking of library calls in the original source environment of the software being ported (described in further detail below). For back-end alone to be invoked, the front-end serves solely as a conduit to the back-end and caches no results in the interim (e.g. the functions being invoked are non-deterministic and hence caching is not sought).

For both the cache and back-end to be invoked, the set of calls kept cached can be either static or dynamic, with the static case covering a predetermined set of calls. The dynamic case can either monotonically increase cache size by accumulating calls over its life or cache flushing can be incorporated, to eliminate calls which no longer remain pertinent. Locality patterns among calls may drive the decisions for cache flushing and accumulation. Regardless of the optional cache use or not, the front-end interfaces with the client program as substitute headers files that link to substitute wrapper functions which invoke the combination of cache/back-end needed to respond to a regular call. Prior to discussing the cache design, we start out by discussing the conservative/safe means of using the stub libraries.

Calls to pure functions, or references to immutable data and type entities can be cached in the front-end, since these calls and references return the same answer each time. Functions that are non-deterministic (for example, those relating to the time or date), or that have greater consequences (such as internal state manipulations, or effects on the operating system state) are verified individually whether or not a caching approximation for the functions suffices. For example, if the implications for the operating system do not involve a manual or automatic feedback loop to the program's execution, such as an error log print to a file which is not seen or used during the program execution, then a cached version of the print function, returning successful following each invocation, can be used instead of the original function. On the other hand, if the error log is needed, then the print function on the back-end can be invoked, storing the file locally on the back-end platform.

For non-deterministic functions (for example, a random “coin flip”), if for the temporary purposes of migration intermediates or initial development, the first value returned by the function can be used as a stand-in function. A cached version of the function can consequently be used. The cached value can be periodically refreshed using the back-end to provide a more realistic approximation, if needed. While standard compiler techniques can automatically verify whether or not a function is pure in some cases, in general, decision-making for whether a given function can have a stub substitute is made manually. This manual step includes a verification of the extent to which the library function is coupled to the application process through shared state, in order for marshalling/unmarshalling techniques to be able to separate the library out as a distributed backend process. For example, the entire heap/stack of the library process may be accessible via pointers from the arguments passed between the application and the library. While this is a degenerate case, such tight coupling argues against use of such functionality via stub functions. In this case, only a relatively loosely-coupled subset of the library may be turned into stub versions, if feasible.

Finally, for references to mutable data types (including classes that create objects/data structures with mutable data fields), read and write operations over the mutable data may be carried out using standard getter and setter methods. These methods turn these references into ordinary function calls whose treatment is as described above.

A library may have inherent platform dependencies, and so may not behave identically on distinct platforms. For example, a library function dependent on the Endian-ness (little Endian hardware versus big Endian hardware) of the underlying platform may behave differently if the back-end resides on a different hardware than the front-end. Since platform-dependent behavior of a library is not common, such behavior may be encountered only irregularly. If this behavior does, however, arise, then the choices of platforms on which the back-end should be run is reduced to ones compatible with the front-end. That is, the back-end and front-end must be run on hardware sharing the same Endian-ness.

Another issue of platform dependencies comprises interface change of the functions from one platform to another (for example, function value return changing to side-effects to a pass-by-reference argument). Such interface changes are handled by localized wrappers. In the example change above, the wrapper creates a local temporary variable and passes that by reference, followed by dereferencing the result later, and returning the result as the answer. The wrapped functions link to appropriately modified library headers on the back-end platform, and additionally respond to the front-end requests through usual distributed process communication means.

Creation of a cache can be function specific, letting individual function wrappers do the argument/answer storing and management or the same can be carried out in space shared among multiple functions, in which case, the function identity also needs to be stored along with the arguments and answers. Bookkeeping information including temporal order among calls, frequency of individual calls, and so on, can be stored along with the same for deciding when to recover space by removing unused calls, or to re-organize the table for faster access due to more commonly used calls. Common tabular data structures, such as hash tables and lists (association lists) can be used for this purpose. The space sharing method is preferred for uniformity and simplicity, using standard marshalling and unmarshalling apparatus for converting all cache-related functions, arguments and answers to a standardized sequence of bytes to be stored in the shared space. Besides integral bookkeeping data, the shared table thus stores only byte representations of the concerned objects. For a prompter response, not all cached entities may be stored in the common table, since the runtime overhead of marshalling and unmarshalling may outweigh the benefits of simplicity and uniformity. Regardless, any combination of the two approaches suffices for the cache design.

Cache information for an individual function can also be derived from call information gathered from multiple runs of the original application on the source platform. Designations of temporal or concurrent partial order can factor into apparent timelines, allowing for contextual designations as to which cached values should be used. For example, several runs against the source platform can result in call histories of which calls are made and in what order, along with their values. These call histories can then be compared to call histories found during testing, and based on which source history compares, the counterpart values from that history can be used. In this scenario of usage, the odds are improved in using correct and consistent data throughout the call history. Optimizations regarding the collapsing of call histories into merged history graphs are a further refinement that may be adopted.

FIG. 4 schematically represents the architecture of a stub library as described herein. A client program 410 links to the library package's header. The usual header is substituted by the header 420 as indicated, by the use of which, the object code vector 430 is linked to. A library function abc( ) in source code 410 is shown linking to abc1( ) 430 in the stub front-end thus. Calls to abc1( ) 430 first refer to a front-end cache 435 as indicated, followed by interprocess/distributed communication to the back-end image. For the back-end image, two vectors are shown, one showing the wrapper code 440 and the other showing the actual library 450. Modified header files for building the front-end and back-end code vectors are not shown in FIG. 4 since the build process for the vectors follows usual methods.

Populating the cache occurs dynamically in the sequence that the individual calls are made. For collating a cache of predetermined calls (for example, for inventory of library usage on the source platform), the stub front-end and back-end processes are invoked and configured on the same original platform so that the marshalling-based cache tables are built up. The tables are then saved and made available for use later in contexts where no back-end process is created. Performance improvement can be achieved by converting the marshalled-data tables to their unmarshalled equivalents in the deployment scenarios, so that no dynamic unmarshalling overhead is incurred each time a call to the library are made. Besides software porting or migration, stub libraries can also be used in ab initio software development. In such a context, an anticipated sequence of function calls can be generated and used to build up a predetermined cache. If libraries are not available for this purpose, then stand-in answers can also be provided to build up the predetermined approximate cache as required. This ability to build a cache without any library use can be of value in porting/migration contexts also when, for example, an initial library inventory is missing or inadequate.

Overview of Global Algorithm

Returning to the planning problem, only overall orchestration, as represented in and described with reference to FIG. 1, relies on the effort attributes of abstract edges in global planning. In iteration planning, the abstract edge estimate is further refined to its specific concrete context (code is already migrated along earlier iterations/edges). This includes detailed refined analyses and test-related costs. Overall orchestration need not obsess about estimation accuracy so long as the relative size of all estimates, vis-à-vis each other, is stable. Hence faster, weighted, metrics- and metric-functions-based analyses can be used in the estimates. Specifically, for modeling safe remediation, and assuming limited interference among remediations as before, the process step of each remediation is reviewed or supervised by a user, so that remediation costs become proportional to the number or porting issues of a given kind. This includes variations due to choices in menu items (providing alternatives for remediation changes to be made), and limited amounts of manually-typed remediation. Proportionality constants for individual issues are provided by user expertise and experience. The cost of more complex issues (such as Endian issues) can be specified by a user. The cost may be specified as a formula/function of Endian and other metrics.

The overall planning process is intended to reduce overall computational effort. The number of iterations in which integrated tests and builds, and unit tests and builds, occur—as depicted in FIG. 1—are to be maximized. The tests and builds desirably evenly space analyze and fix (that is, code remediation) efforts so that the testing practices occur roughly after a regular number of porting efforts. This relates to regular compile-time and run-time testing, and increasing their frequency. Testing at irregular intervals is undesirable since the longer (untested) intervals may scale testing costs super-linearly, while shorter intervals may only add the testing overhead without much benefit from the activity.

Overall computational effort is reduced in the full graph by solving the shortest weighted path problem, which Dijkstra's algorithm specifies as having a complexity of O(n²) for an n vertices graph. In an abstract graph, the problem is framed as follows. Let diff represent the set of E/Q variables that are differently set for the source and target dialects. That is, the diff set comprises E/Q variables that have different values for the source and target dialects. Given the definition of the abstract graph, the shortest weighted path from source to target must include at least one edge (weight) per variable in the diff set. There can be other edges, due to synchronization constraints, but a minimum weight bound is formed by these diff edges. A lower bound for this can be computed by summing the least weight edges for individual variables in the diff set. If the shortest weighted path contains only edges corresponding to variables in the diff set (one per variable), then the path is called a detour-free path.

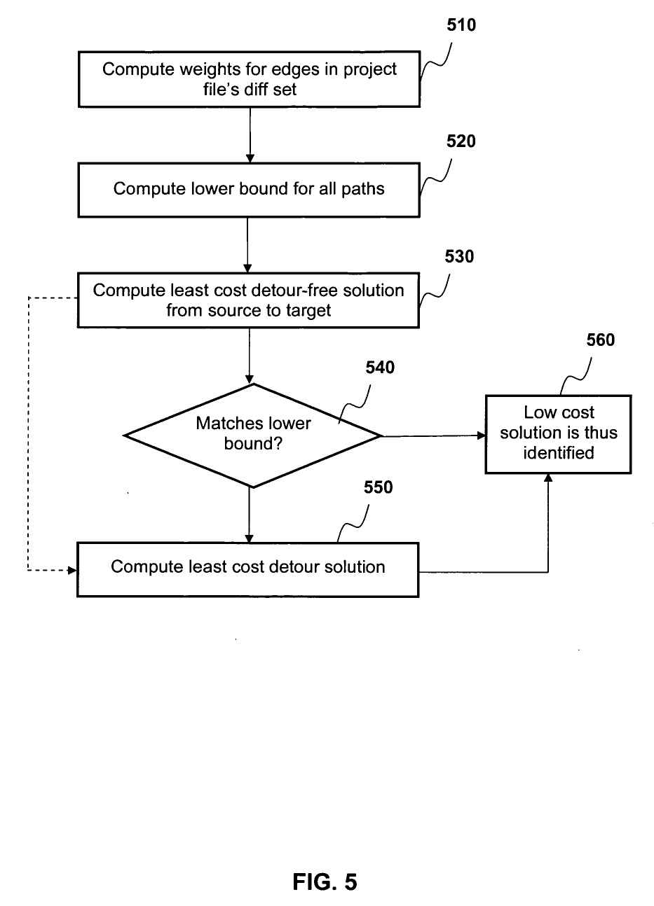

An algorithm to compute the overall plan is as outlined below. FIG. 5 is a flow chart that presents the steps of this algorithm. First, the weights for all edges in a project file's diff set are computed in step 510. The lower bound on the shortest weighted path is computed in step 520 by summing minimum path weights (from source setting to target setting) for variables in the diff set. Next, using the No-Detour algorithm (described in further detail below), a least cost detour-free solution from the source to target is computed (if possible) in step 530. The solution comprises a set of edges and a temporal partial order covering synchronization and implication constraints. If no solution is found, a detouring path, with notional cost of a detour-free path set to ∞, can be used to find a possible answer and thereafter stop, as indicated by the dashed line. Given a lower bound to path cost, and a detour-free candidate's cost, this step can be used to identify any edge set combinations for the diff and other variables which: (a) cover the diff-variables' edges and (b) cost less than the detour-free path's cost. For each such combination, the objective is to keep the total cost below the known detour-free cost while meeting synchrony constraints. If the cost exceeds the detour-free cost, the search attempt is pruned.

If a detour-free solution is found in step 530 above, a check is made in step 540 if this solution matches the lower bound cost computed in step 520. If so, the lowest cost solution is thus identified (step 560) and no further processing is required.

Algorithm for Computing Detour-Free Paths

First, for a detour-free path, a forest of one AND/OR tree per diff variable is constructed. For a diff variable, suppose that there are m edges for the source-to-target value change. An OR node is constructed as the root with up to m children, with each child corresponding to one of the m edges such that the synchronization set (if any) of the edge can belong to a detour-free path. An AND node is constructed for each such child, with one sub-tree per diff-variable-modifying edge in the synchronization set such that it takes the diff-variable from the source to target setting.

If the synchronization set is null (for example, an unsynchronized edge), then the AND node is a leaf node. If the synchronization set contains an edge other than a diff-variable-modifying edge as above, then the synchronization constraint may potentially cause a detour and hence is not solved for and the child tree below the OR node is pruned. Similarly, cycles in the synchronization constraints are pruned.

The sub-trees of an AND node are constructed recursively, just as for a root diff variable. Following this construction, each tree is checked for the possibility of a leaf OR node. The tree above such a leaf OR node is pruned up-to the child of the top-level OR node of the tree. If the top-level OR node of the tree becomes a leaf as a result, a detour-free path is by implication not possible and the algorithm is stopped.

After leaf-OR screening, each tree is known to comprise alternating levels of OR and AND nodes, with a multi-arity OR node as the root and all leaf nodes being AND nodes. A subset of trees in the forest is marked using a single top-down traversal for a tree. Only one child of any OR node is marked in a traversal. All children of an AND node are marked in a traversal.

A set of markings wherein the marked edges (basically AND nodes) cover the set of diff variables is computed. Each such marking identifies a detour-free solution with a weight equal to the sum of the edge weights. The ancestor-descendent order in a marking also represents temporal constraints pertinent to edge execution (descendent precedes ancestor).

Duplicate presence of an edge in a marking is eliminated as follows. One of the edge copies (an AND node) is selected, as is its sub-tree as the shared tree for all ancestors of the edge. The sub-trees under the discarded duplicates are similarly merged into other nodes or, if this is not possible, the sub-trees are converted into a separate tree and added to the forest. Each edge to a target variable setting that implies other variable settings is preceded by edges that ensure the implied variable settings. Temporal edges among these edges are verified, or explicitly added and, if not possible, the detour-free solution is abandoned.

Regular Testing and Iteration Planning

Candidate solutions, with given temporal order among edges, are ranked by their effort costs within a fixed range above the minimum effort. For each solution, additional temporal order is added in an attempt to maximize vertices with better testing support along the path and regular spacing among the tests. An alternative strategy is to let a user suggest detour variables that are set and reset en route to the destination, so that migration proceeds in a more testable space. As an example, consider a scenario of porting from little Endian to little Endian machines, all testable paths being on big Endian machines, and the original code being relatively Endian neutral.

The overall plan provides a partially-ordered edge set, the conversion of which to a totally-ordered set is based on local decision making in iteration planning. Alignment of migration steps among different files for simpler makefile migration is considered in this step. More detailed analyses, based on actual issues, manual code inspection, test case development, and so on, feed this exercise. Availability of the relevant human skills can also decide which iteration to undertake at a given time.

Robust testing coverage may also dictate some of the local decisions at iteration planning level, such as the need to exercise certain dialect variables prior to exercising others. For example, in the example presented in Table 1, the Endian testing predicate has a bug, which makes its working fragile (valid solely on 64-bit platforms, or on the source 32-bit, Little Endian platform). To thoroughly exercise such poorly-constructed porting-related code fragments, one can exercise the Endian settings prior to exploring changes in the 32/64 bit settings. Knowledge of the dialect settings and the codebase may dictate such testing policies. Such policies add further order to the partial order provided by the overall plan. Such policy imposition may be considered as a post-processing step after overall plan generation, or as a part of the iteration planner, either of which provides an equivalent function.

Computer Hardware

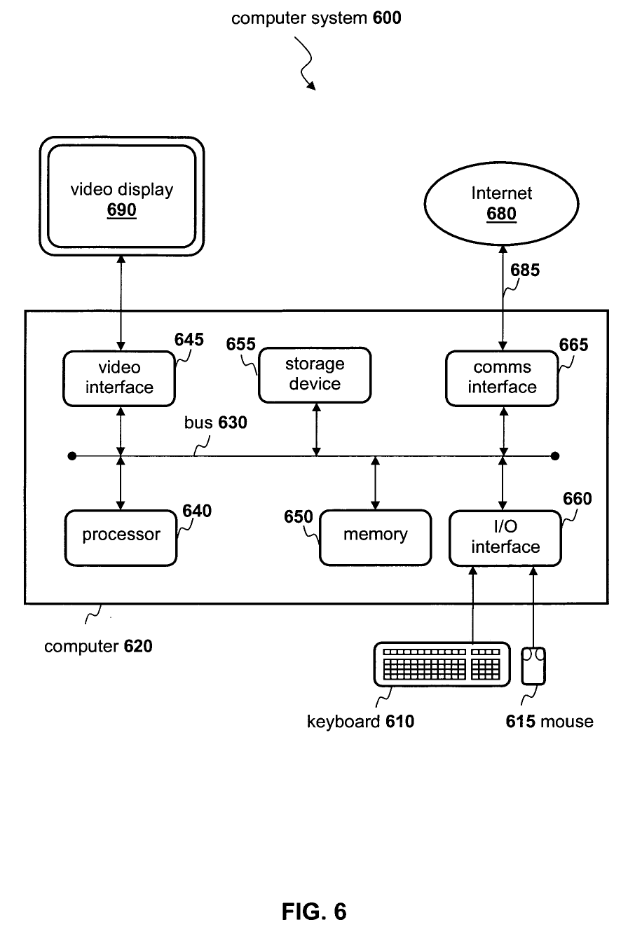

FIG. 6 is a schematic representation of a computer system 600 suitable for executing computer software programs for performing the computation steps described herein. Computer software programs execute under a suitable operating system installed on the computer system 600, and may be thought of as a collection of software instructions for implementing particular steps.

The components of the computer system 600 include a computer 620, a keyboard 610 and mouse 615, and a video display 690. The computer 620 includes a processor 640, a memory 650, input/output (I/O) interface 660, communications interface 665, a video interface 645, and a storage device 655. All of these components are operatively coupled by a system bus 630 to allow particular components of the computer 620 to communicate with each other via the system bus 630.

The processor 640 is a central processing unit (CPU) that executes the operating system and the computer software program executing under the operating system. The memory 650 includes random access memory (RAM) and read-only memory (ROM), and is used under direction of the processor 640.

The video interface 645 is connected to video display 690 and provides video signals for display on the video display 690. User input to operate the computer 620 is provided from the keyboard 610 and mouse 615. The storage device 655 can include a disk drive or any other suitable storage medium.

The computer system 600 can be connected to one or more other similar computers via a communications interface 665 using a communication channel 685 to a network, represented as the Internet 680.

The computer software program may be recorded on a storage medium, such as the storage device 655. Alternatively, the computer software can be accessed directly from the Internet 680 by the computer 620. In either case, a user can interact with the computer system 600 using the keyboard 610 and mouse 615 to operate the computer software program executing on the computer 620. During operation, the software instructions of the computer software program are loaded to the memory 650 for execution by the processor 640. Other configurations or types of computer systems can be equally well used to execute computer software that assists in implementing the techniques described herein.

### EXAMPLE

Consider an example relating to the code fragment of Table 1 above. The unspecified code (denoted by ellipses—“ . . . ”) can be considered as containing calls to a threads package sthreads on the source platform. On the target platform, these calls are re-mapped to tthreads or target threads. Such an example may be analyzed by a command of the sort: “ccfrontend -c90 -oldforinit -target=LE -wordSize=32-I sthreadpath filename.c” at the source platform, and by a command of the sort: “ccfrontend -c99 -target=BE -wordSize=64 -I tthreadspath filename.c” at the target platform. The dialect variables as described for Table 1 translate into the compiler settings similar to those indicated in the commands described above.

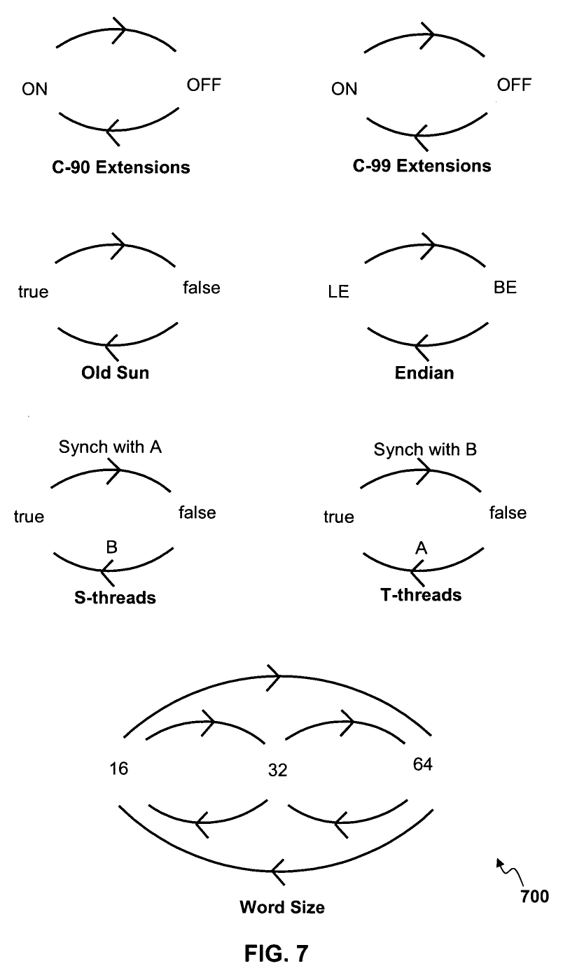

FIG. 7 depicts an abstract graph 700, which comprises a set of dialects and edges with supporting translations into compiler commands, as noted above. Not all possible compiler commands are supported in the abstract graph 700 at a given time, only a sufficiently large set so as to cover typical source and target migration points, with enough breadth to be able to slice the migration problem into individual iterations. The abstract graph 700 covers the detour-free paths and extra bit settings. The threads packages in the abstract graph 700 are synchronized, so that the removal of one package does not force sequentialization of the application code at an intermediate migration point.

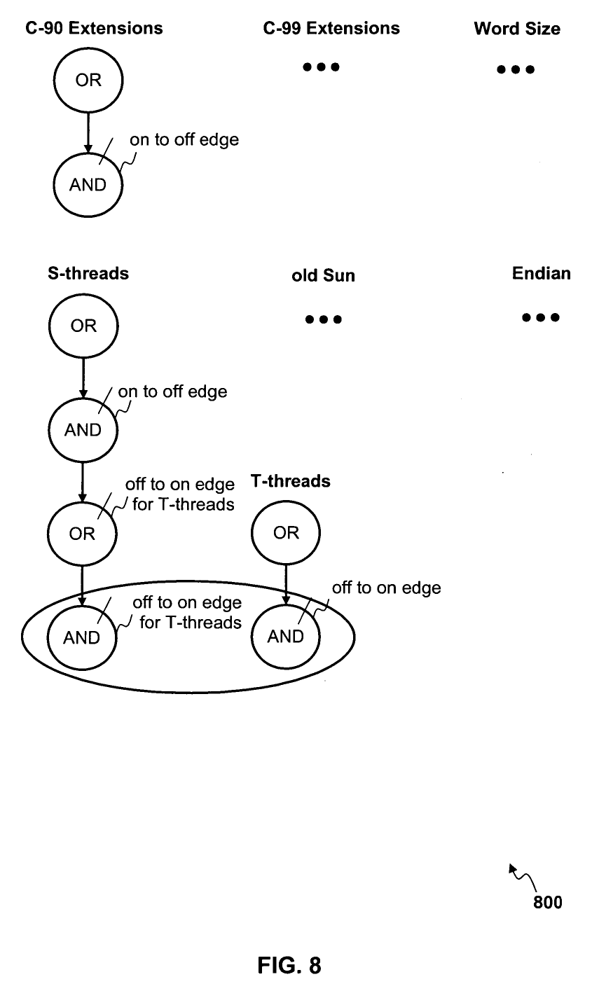

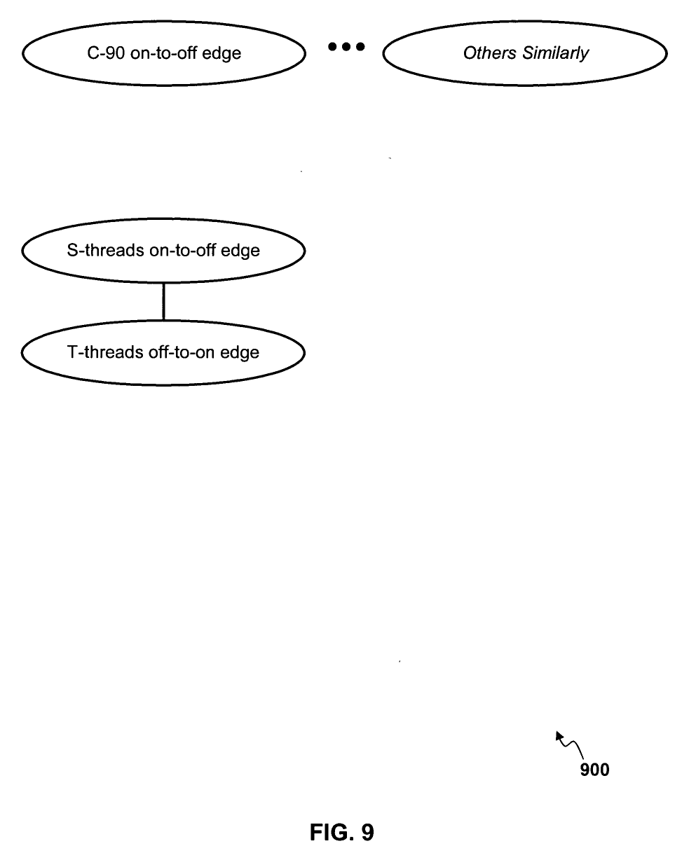

FIG. 8 depicts AND/OR trees 800 constructed for the migration, along with the sole marking possible for this example. FIG. 9 depicts the partially-ordered migration edges 900 for the trees 800 of FIG. 8. If there are multiple distinct markings, multiple partial orders are possible for the migration edges. Either one such partial order or a unified combination of the partial orders (possibly selected with user assistance) may be selected. A selection is made to minimize effort and maximize regular testing.

During local iteration planning, the user is free to collapse temporal edges to execute multiple edge migrations simultaneously. One can assume that edges are of zero time. As an example, removing source threads and including target threads may be performed in one shot. The user may also wish to add detours to the above path, such as porting to 16 bits, prior to the shift to 64 bits, for robust porting. Such detours may either be made at the user's discretion, or suggested by an existing policy, at the time of local iteration planning. If a detour-free solution is not found, detours may be explored using a greedy approach, by including the detour edges needed by the synchronization constraints of the diff edges. The inclusion of a non-diff edge also requires the inclusion of its reverse path else the target dialect is not reached. This is straightforward to enforce if the synchronization constraints on the reverse path are minimal.

### CONCLUSION

Appropriate use of the tool-based porting process described herein is expected to provide advantages for enterprise-scale porting projects, in terms of economic, throughput, and latency benefits. The process described herein addresses the limitations conventionally associated with XP in a manner that may be summarized as follows. Pair programming expands knowledge transfer quadratically, thereby limiting scalability, but such knowledge can be tabularized for easy reference. Compilation unit familiarity is valuable, but not needed on a team-wide basis, and is thus maintained in a discontinuous pair programming manner. Planning game, with orchestrator support, is substantially simplified and partitioned into disjoint estimating activities so as to no longer be a group introspection bottleneck. Refactoring can insert informative (audit) logs for each porting issue/remediation, which allows one to retain issue-by-issue ownership and responsibility (and credit) for individuals in collective code change. Thus collective ownership need no longer lead to chaos. Metaphor weakness can be overcome by the backup information comprising dialect change and porting issue details. Finally, ease of partitioning simplifies any intricate collaboration expectations among multiple team-based organizations.

Various alterations and modifications can be made to the tool-based porting process described herein, as would be apparent to one skilled in the relevant art.

1. A method for migrating computer software code from a source platform to a target platform, the method comprising:
generating a migration plan specifying a set of migration stages from source dialect settings to the target dialect settings via intermediate dialect settings, and a partial ordering of the migration stages based upon dependencies between the dialect settings; and
executing the migration plan as a complete sequence of migration stages consistent with the partial ordering specified by an initial migration plan, in which each of the migration stages specifies a transition between preceding dialect settings and succeeding dialect settings and is executed by:
identifying migration issues in the software code arising from transition from the preceding dialect settings to the succeeding dialect settings;
modifying the software code to resolve identified migration issues for the succeeding dialect settings; and
building modified software code with the succeeding dialect settings.

2. The method as claimed in claim 1, further comprising representing the migration plan as an abstract graph, wherein the intermediate dialect settings are represented as vertices of the abstract graph, and the migration stages between the intermediate dialect settings are represented as intra-variable edges of the abstract graph.

3. The method as claimed in claim 2, wherein the migration plan further specifies synchronization constraints between the intermediate dialect settings.

4. The method as claimed in claim 1, further comprising assigning estimated migration costs to the migration stages.

5. The method as claimed in claim 4, wherein the migration plan is executed to minimize the estimated migration costs of the complete sequence of migration stages.

6. The method as claimed in claim 1, further comprising computing set recording differences between the source dialect settings and the target dialect settings.

7. The method as claimed in claim 6, wherein the migration plan includes at least one migration stage for each dialect variable represented in a recorded difference set.

8. The method as claimed in claim 1, further comprising combining a selection of the migration stages into a single migration stage.

9. The method as claimed in claim 1, further comprising concurrently debugging the modified software code and unmodified software code, wherein respective breakpoints are set for identified migration issues at corresponding program locations.

10. The method as claimed in claim 9, further comprising comparing, for each of the respective breakpoints, results of the process of debugging on the modified software code and the unmodified software code.

11. The method as claimed in claim 9, further comprising specifying, for each of the migration stages, one or more policies for testing the modified software code and the unmodified software code.

12. The method as claimed in claim 1, further comprising generating an audit log for each identified migration issue.

13. The method as claimed in claim 1, further comprising accessing a predetermined cache of results for function calls of the software code.

14. A computer program product comprising:
a storage medium readable by a computer system and for recording software instructions executable by a computer system for implementing a method comprising:
generating a migration plan specifying a set of migration stages from source dialect settings to the target dialect settings via intermediate dialect settings, and a partial ordering of the migration stages based upon dependencies between the dialect settings; and
executing the migration plan as a complete sequence of migration stages consistent with the partial ordering specified by an initial migration plan, in which each of the migration stages specifies a transition between preceding dialect settings and succeeding dialect settings and is executed by:
identifying migration issues in the software code arising from transition from the preceding dialect settings to the succeeding dialect settings;
modifying the software code to resolve identified migration issues for the succeeding dialect settings; and
building modified software code with the succeeding dialect settings.

15. A computer system comprising:
a processor for executing software instructions;
a memory for storing software instructions;
a system bus operatively coupling the memory and the processor; and
a storage medium recording software instructions that are loadable to the memory for execution by said processor to perform a process of:
generating a migration plan specifying a set of migration stages from source dialect settings to the target dialect settings via intermediate dialect settings, and a partial ordering of the migration stages based upon dependencies between the dialect settings; and
executing the migration plan as a complete sequence of migration stages consistent with the partial ordering specified by an initial migration plan, in which each of the migration stages specifies a transition between preceding dialect settings and succeeding dialect settings and is executed by:
identifying migration issues in the software code arising from transition from the preceding dialect settings to the succeeding dialect settings;
modifying the software code to resolve the identified migration issues for the succeeding dialect settings; and
building modified software code with the succeeding dialect settings.
